(19) United States
(12) Patent Application Publication
(10) Pub. No.: US 2006/0159310 A1
(43) Pub. Date: Jul. 20, 2006

(54) Image velocity estimation

(76) Inventors: Djamal Boukerroui, Compiegne (FR); Julian Alison Noble, Oxford (GB)

Correspondence Address: NIXON & VANDERHYE, PC, 901 NORTH GLEBE ROAD, 11TH FLOOR, ARLINGTON, VA, 22203, US

(21) Appl. No.: 10/537,789

(22) PCT Filed: Nov. 19, 2003
(86) PCT No.: PCT/GB03/05047

§ 371 Date: Jul. 19, 2005

(30) Foreign Application Priority Data
Dec. 4, 2002 (GB) 0228300.0

(51) Int. Cl. G06K 9/00; H04N 5/14

(52) U.S. Cl. 382/107; 348/699

(57) ABSTRACT

A method of image velocity estimation in image processing which uses a block matching technique in which a similarity measure is used to calculate the similarity between blocks in successive images. The similarity measure is used to calculate a probability density function of candidate velocities. The calculation is on the basis of an exponential function of the similarity in which the similarity is multiplied by a parameter whose value is independent of position in the frame. The candidate velocities are thresholded to exclude those having a low probability. The value of the parameter and threshold are optimised together by coregistering all frames to the first frame, calculating the registration error, and varying them to minimise the registration error. The similarity measure is normalised with respect to the size of the block, for example by dividing it by the number of image samples in the blocks being compared. The similarity measure used may be the CD_{2-bis} similarity measure in which the mean and standard deviation of the two blocks being compared are adjusted to be the same before calculation of the similarity. This makes the similarity measure particularly suitable for ultrasound images. Further, block matching may be conducted across three frames of the sequence by comparing the intensities in blocks in the first and third, and second and third of the frames and finding the block in the third frame which best matches the block in the second frame and that block's corresponding position in the first frame.

The present invention relates to image processing, and in particular to improving the estimation of image velocity in a series of image frames.

There are many imaging situations in which a subject in an image is in motion and it is desired to track or measure the movement of the subject from frame to frame. This movement is known as optical flow or image velocity. Such estimation or measurement of image velocity may be done, for example, to improve the efficiency of encoding the image, or to allow enhancement of the display of, or measurement of, the movement of some particular tracked part of the image to assist an observer trying to interpret the image. Many techniques have been proposed and used for image velocity estimation and one of the basic techniques is known as block matching. In block matching, blocks of pixels are defined in a first frame and the aim is then to identify the position of those blocks in a second subsequent frame. One approach is to compare the intensities of the pixels in the block in the first frame with successive, displaced candidate blocks in the second frame using a similarity measure, such as the sum of square differences. The block in the second frame which gives the minimum of the sum of square differences (or gives the best match with whichever similarity measure is chosen) is taken to be the same block displaced by movement of the subject. Repeating the process for successive blocks in the first image frame gives an estimate for the subject motion at each position in the image (the image velocity field).

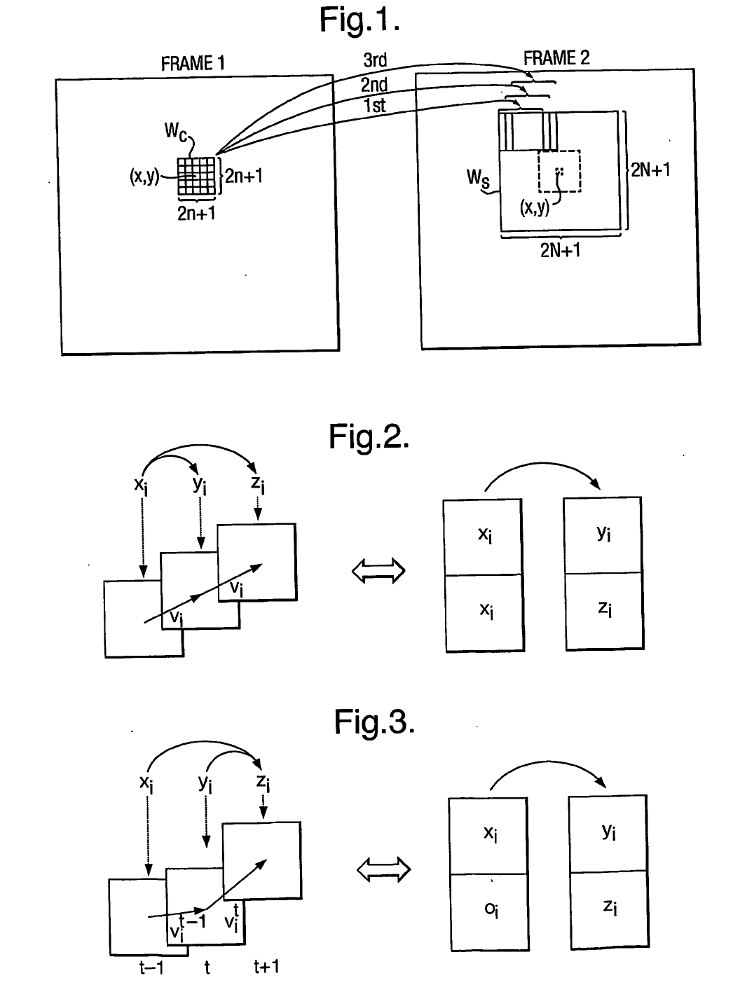

FIG. 1 schematically illustrates the idea. Two frames are shown, frame 1 and frame 2. These may be, but are not necessarily, successive frames in a sequence. Frame 1 is divided up into square blocks of pixels having a side length of (2n+1) pixels, ie. from −n to +n about a central pixel (x, y) in each block. One block W_{c} is illustrated in FIG. 1. A search window Wₛ is defined in the second frame around the position of the corresponding central pixel (x, y) in the second frame. As illustrated in FIG. 1 it is a square search region of side length (2N+1) pixels. The intensities of the block W_{c} of pixels in frame 1 are then compared at all possible positions of the block in the search window Wₛ. So, for example, the first comparison is made with the corresponding (2n+1) by (2n+1) block in the top left hand corner of the search window Wₛ, and then with such a block displaced one pixel to the right, and then a block displaced two pixels to the right and so on until the end of the search window is reached. The procedure is then repeated for a row of candidate blocks displaced one pixel down in the search window from the first row, and so on until the bottom of the search window is reached. The similarity measure may, for example, be a sum of square differences:

$${E}_{c} ( u , v ) = {\sum }_{i = - n}^{n} {\sum }_{j = - n}^{n} {[ I ( x + i , y + j , t ) - I ( x + u + i , y + v + j , t + 1 ) ]}^{2} \qquad ( 1 )$$

for each value of (u, v) for −N≦u, v≦N and where i and j index through the block W_{c} centered on the pixel (x , y) in the x and y directions respectively, and u and v are the different values of displacement which index over the search window Wₛ. The values u and v can, given the time difference between the frames, be regarded as a velocity. This gives a value of E_{c} for each estimated displacement. The estimated displacement with the minimum E_{c} is often taken as the actual displacement of the block. This is repeated for all positions in frame 1 to give a velocity field, and then for all frames in the sequence. Different similarity measures may, of course, be used. Also, it is not always necessary to conduct the block matching on all frames of the sequence, or for all pixels or blocks in each frame. The block W_{c} may subsample the pixels in the frame and the candidate displacements u and v may be indexed by more than one pixel. Thus the searching may be at different resolutions and scales. Sometimes a multi-scale and/or multi-resolution approach may be used in which block matching is first performed at a coarse resolution or large scale, and subsequently at successively finer resolutions, using the previously calculated velocity values to reduce the amount of searching required at finer resolutions.

Medical images present many difficulties in image processing because of the typically high level of noise found in them. For example, the tracking of cardiac walls in cardiac ultrasound images is difficult because of the high level of noise found in ultrasound images and also because of the nature of the cardiac motion. In particular, the cardiac motion varies during the cardiac cycle. Various ways of identifying and tracking cardiac walls in echocardiograms have been proposed in WO 01/16886 and WO 02/43004, but it is a difficult task in which there is room for improvement.

A development of the block matching technique as described above has been proposed by A. Singh, “Image-flow computation: An estimation-theoretic framework and a unified perspective,” CVGIP: Image understanding, vol. 65, no. 2, pp. 152-177, 1992 which is incorporated herein by reference. In this approach both conservation information, e.g. from a block matching technique as described above, and neighbourhood information (i.e. looking at the velocities of surrounding pixels) are combined with weights based on estimates of their associated errors. Thus in a first step based on conservation information the similarity values E_{c} are used in a probability mass function to calculate a response R_{c}whose value at each position in the search window represents the likelihood of the corresponding displacement. The probability mass function is given by

$${R}_{c} ( u , v ) = \frac{1}{Z} exp ( - k {E}_{c} ( u , v ) ) , \qquad ( 2 )$$

where Z is defined such that all probabilities sum to unity i.e.:

$${\sum }_{u = - N}^{N} {\sum }_{v = - N}^{N} {R}_{c} ( u , v ) = 1 \qquad ( 3 )$$

In the function for the response the parameter k is chosen at each position such that the maximum response in the search window is close to unity (0.95 before normalisation) for computational reasons. The expected value of the velocity is then found by multiplying each candidate value by its probability and summing the results:

$$\begin{matrix}{u}_{cc} = {\sum }_{u = - N}^{N} {\sum }_{v = - N}^{N} u {R}_{c} ( u , v ) & ( 4 ) \\ {v}_{cc} = {\sum }_{u = - N}^{N} {\sum }_{v = - N}^{N} v {R}_{c} ( u , v ) & ( 5 )\end{matrix}$$

Another velocity estimate may be obtained by the use of neighbourhood information. In other words, the velocity at each pixel is unlikely to be completely independent of the velocity of its neighbours. Thus, assuming that the velocity of each pixel in a small neighbourhood Wₚ has been estimated, the velocity estimates for each pixel can be refined by using the velocity of its neighbouring pixels. Clearly it is more likely that the velocities of closer neighbours are more relevant than pixels which are further away. Therefore weights are assigned to velocities calculated for the neighbouring pixels, and the weights drop with increasing distance from the central pixel (a 2-D Gaussian mask in the window Wₚ of size (2w+1)(2w+1) is used). These weights can be interpreted as a probability mass function Rₙ=(uᵢ,vᵢ) where

$${\sum }_{{x}_{i} ∈ {W}_{p}} {R}_{n} ( {u}_{i} , {v}_{i} ) = 1$$

(i is an index for pixels in Wₚ) in a uv space. Now, the velocity estimate U=(\overline{u},\overline{v}) for the central pixel using neighbourhood information can be calculated as:

$$\begin{matrix}\overline{u} = {\sum }_{{x}_{i} ∈ {W}_{p}} {u}_{i} {R}_{n} ( {u}_{i} , {v}_{i} ) & ( 6 ) \\ \overline{v} = {\sum }_{{x}_{i} ∈ {W}_{p}} {v}_{i} {R}_{n} ( {u}_{i} , {v}_{i} ) & ( 7 )\end{matrix}$$

An important aspect of the Singh approach is that a covariance matrix is calculated for each velocity estimate, for both the estimates based on conservation information and the estimates based on neighbourhood information. These covariance matrices can be used to calculate errors which are used as weights when combining the two estimates together to give a fused, optimal estimate.

The covariance matrix corresponding to the estimate U_{cc} is given by:

$${S}_{cc} = [ \begin{matrix}{\sum }_{u = - N}^{N} {\sum }_{v = - N}^{N} {( u - {u}_{cc} )}^{2} {R}_{c} ( u , v ) & {\sum }_{u = - N}^{N} {\sum }_{v = - N}^{N} ( u - {u}_{cc} ) ( v - {v}_{cc} ) {R}_{c} ( u , v ) \\ {\sum }_{u = - N}^{N} {\sum }_{v = - N}^{N} ( u - {u}_{cc} ) ( v - {v}_{cc} ) {R}_{c} ( u , v ) & {\sum }_{u = - N}^{N} {\sum }_{v = - N}^{N} {( v - {v}_{cc} )}^{2} {R}_{c} ( u , v )\end{matrix} ] \qquad ( 8 )$$

The covariance matrix corresponding to the neighbourhood estimate \overline{U} is as follows:

$${S}_{n} = [ \begin{matrix}{\sum }_{{x}_{i} ∈ {W}_{p}} {( {u}_{i} - \overline{u} )}^{2} {R}_{n} ( {u}_{i} , {v}_{i} ) & {\sum }_{{x}_{i} ∈ {W}_{p}} ( {u}_{i} - \overline{u} ) ( {v}_{i} - \overline{v} ) {R}_{n} ( {u}_{i} , {v}_{i} ) \\ {\sum }_{{x}_{i} ∈ {W}_{p}} ( {u}_{i} - \overline{u} ) ( {v}_{i} - \overline{v} ) {R}_{n} ( {u}_{i} , {v}_{i} ) & {\sum }_{{x}_{i} ∈ {W}_{p}} {( {v}_{i} - \overline{v} )}^{2} {R}_{n} ( {u}_{i} , {v}_{i} )\end{matrix} ] \qquad ( 9 )$$

Thus these steps give two estimates of velocity, U_{cc} and \overline{U}, from conservation and neighbourhood information respectively, each with a covariance matrix representing their error. An estimate U of velocity that takes both conservation information and neighbourhood information into account can now be computed. The distance of this new estimate from \overline{U}, weighted appropriately by the corresponding covariance matrix, represents the error in satisfying neighbourhood information. This can be termed neighbourhood error. Similarly the distance of this estimate from U_{cc}, weighted by its covariance matrix, represents the error in satisfying conservation information. This may be termed conservation error. The sum of neighbourhood and conservation errors represents the squared error of the fused velocity estimate:
ε²=(U−U_{cc})^{T}S_{cc}⁻¹(U−U_{cc})+(U−\overline{U})^{T}Sₙ⁻¹(U−\overline{U}) (10)

The optimal value of velocity is that value which minimises this error and can be obtained by setting the gradient of the error with respect to U equal to zero giving:

$${\hat{U}}_{op} = {[ {S}_{cc}^{- 1} + {S}_{n}^{- 1} ]}^{- 1} [ {S}_{cc}^{- 1} {U}_{cc} + {S}_{n}^{- 1} \overline{U} ] \qquad ( 11 )$$

Because the values of \overline{U} and Sₙ are derived on the assumption that the velocity of each pixel of the neighbourhood is known in advance, in practice equation (11) is solved in an iterative process (via Gauss-Seidel relaxation) with the initial values of the velocity at each pixel being taken from the conservation information alone. Thus:

$$\{ \begin{matrix}{U}^{0} = {U}_{cc} \\ {U}_{op}^{m + 1} = {[ {S}_{cc}^{- 1} + {S}_{n}^{- 1} ]}^{- 1} [ {S}_{cc}^{- 1} {U}_{cc} + {S}_{n}^{- 1} \overline{{U}_{op}^{m}} ]\end{matrix} \qquad ( 12 )$$

where the superscript m refers to the iteration number. Iteration continues until the difference between two successive values of Uₒₚ is smaller than a specified value.

While this technique usefully combines conservation and neighbourhood information, and does so in a probabilistic way, it does not always work well in practice, particularly with noisy images of the type found in medical imaging and ultrasound imaging in general.

Another common problem in image velocity estimation using matching techniques is known as the multi-modal response (i.e. due to the well-known aperture problem, for example, or mismatching especially when the size of the search window is large). A common way to reduce the effect of the multi-modal response is to compare the intensities in three frames, rather than just two as explained above. So the similarity between blocks W_{c} in two frames xᵢ and yᵢ is found, and between two blocks W_{c} in yᵢ and zᵢ, as shown in FIG. 2 of the drawings. In the two frame comparison the intensities in a block W_{c} in one frame xᵢ at time t are compared with the intensities in a corresponding block displaced by the candidate velocity (u,v) in the next frame yᵢ at time t+1 for all values of (u, v) in the search window Wₛ. In the three frame approach, the intensities in the block W_{c} are also compared with the intensities in the block displaced by (2u, 2v) in the next-but-one frame zᵢ at time t+2, again for values of (u, v) in the search window Wₛ. In the case of using sum-of-square differences as the similarity measure this can be written as:

$${E}_{c} ( u , v ) = {\sum }_{i = - n}^{n} {\sum }_{j = - n}^{n} ( \begin{matrix}{[ I ( x + i , y + j , t ) - I ( x + u + i , y + v + j , t + 1 ) ]}^{2} + \\ {[ I ( x + i , y + j , t ) - i ( x + 2 u + i , y + 2 v + j , t + 2 ) ]}^{2}\end{matrix} \qquad ( 13 )$$

where the first term is comparing blocks in the frames at t and t+1 separated by a displacement (u, v) and the second term is comparing blocks in the frames at t and t+2 separated by twice that, i.e. (2u, 2v). This amounts to assuming that the velocity is constant across three frames of the sequence. In other words, for three frames at times t, t+1 and t+2, it is assumed that the displacements between t and t+1 are the same as the displacements between t+1 and t+2. This assumption is reasonable for high frame rate sequences, but is poor for low frame rate sequences, such as are encountered in some medical imaging techniques, including some ultrasound imaging modalities.

The present invention is concerned with improvements to block matching which are particularly effective for medical images, especially ultrasound images, which are inherently noisy.

A first aspect of the invention provides a method of processing a sequence of image frames to estimate image velocity through the sequence comprising:

block matching using a similarity measure by comparing the intensities in image blocks in two frames of the sequence and calculating the similarity between the said blocks on the basis of their intensities, calculating from the similarity a probability measure that the two compared blocks are the same, and estimating the image velocity based on the probability measure, wherein the probability measure is calculated using a parametric function of the similarity which is independent of position in the image frames.

Preferably the parameters of the parametric function are independent of position in the image frames. The function may be a monotonic, e.g. exponential, function of the similarity, in which the similarity is multiplied by a positionally invariant parameter. The parameters may be optimised by coregistering the frames in the sequence on the basis of the calculated image velocity, calculating a registration error and varying at least one of the parameters to minimise the registration error. The registration error may be calculated from the difference of the intensities in the coregistered frames, for example the sum of the squares of the differences.

Thus in the particular example of the approach proposed by Singh the value of parameter k is set for each position (so that the maximum response in the search window is close to unity), meaning that k varies from position to position over the frame. However, with this aspect of the present invention the value of k is fixed over the frame—it does not vary from position to position within the frame. It should be noted that because k is used in a highly non-linear (exponential) function in calculating the response (probability), the velocity and error estimates are not uniform, because variations in the value of k have a large effect. With this aspect of the present invention, on the other hand, k is constant for all pixels in the image, so the processing is uniform across the image and from frame to frame.

The value of k may be optmised, as mentioned, for example by registering all frames in the sequence to the first frame, i.e. using the calculated image velocity to adjust the image position to cancel the motion—which if the motion correction were perfect would result in the images in each frame registering perfectly, and calculating the registration error—e.g. by calculating the sum of square differences of the intensities. The value of k is chosen which gives the minimum registration error.

The calculated similarity may be normalised by dividing it by the number of pixels in the block, or the number of image samples used in the block (if the image is being sub-sampled).

Thus, again in the particular example above, the value of k in equation (2) above for R_{c} may be replaced by k/(2n+1)². This means that the value of k does not need to be changed if the block size is changed. In particular, it does not need to be re-optimised, so that once it has been optimised for a given application (e.g. breast ultrasound) using one frame sequence at one scale and resolution, the same value of k may be used for the same application on other sequences at other scales and resolutions.

The probability measure may be thresholded such that motions in the image velocity having a probability less than a certain threshold are ignored. The threshold may be optimised by the same process as used for optimisation of the parameter k above, i.e. by coregistering the frames in the sequence on the basis of the calculated image velocity, calculating a registration error and varying the threshold to minimise registration error. The threshold may be positionally independent.

A second aspect of the invention relates to the similarity measure used in image velocity estimation and provides that the intensities in the blocks W_{c} in the frames being compared are normalised to have the same mean and standard deviations before the similarity is calculated. The similarity measure may be the CD₂ similarity measure (rather than the sum of square differences of Singh), which is particularly suited to ultrasound images (see B. Cohen and I. Dinstein, “New maximum likelihood motion estimation schemes for noisy ultrasound images”, Pattern Recognition 35 (2002), pp 455-463).

A third aspect of the invention modifies the approach of Singh to avoiding multi-modal responses by assuming that the observed moving tissue conserves its statistical behaviour through time (at least for three to four consecutive frames), rather than assuming a constant velocity between three frames.

This aspect of the invention provides for block matching across three frames of the sequence by comparing the intensities in blocks in the first and third and the second and third of the three frames, and calculating the similarity on the basis of the compared intensities.

The blocks in the first and second frames are preferably blocks calculated as corresponding to each other on the basis of a previous image velocity estimate (i.e. the image velocity estimate emerging from processing preceding frames).

Thus the method may comprise defining for each block in the second frame a search window encompassing several blocks in the third frame, and calculating the similarity of each block in the search window to the said block in the second frame and to the corresponding position of that said block in the first frame (as deduced from the previous image velocity estimate). Thus this avoids assuming that the velocity remains the same through the three frames. It is therefore suited to image frame sequences having a relatively low frame rate, where the assumption of constant velocity does not tend to hold.

The different aspects of the invention may advantageously be combined together, e.g. in an overall scheme similar to that of Singh. Thus, as in the Singh approach the estimated image velocity using the technique above may be obtained by summing over the search window the values of each candidate displacement multiplied by the probability measure corresponding to that displacement. Further, the estimate may be refined by modifying it using the estimated image velocity of surrounding positions—so-called neighbourhood information.

The techniques of the invention are particularly suitable for noisy image sequences such as medical images, especially ultrasound images.

The invention also provides apparatus for processing images in accordance with the methods defined above. The invention may be embodied as a computer program, for example encoded on a storage medium, which executes the method when run on a suitably programmed computer.

The invention will be further described by way of example, with reference to the accompanying drawings in which:

FIG. 1 illustrates schematically a block matching process;

FIG. 2 illustrates schematically a similarity measure calculation using a constant velocity assumption for three frames;

FIG. 3 illustrates a similarity measure calculation using the assumption of statistical conservation of moving tissue for three frames;

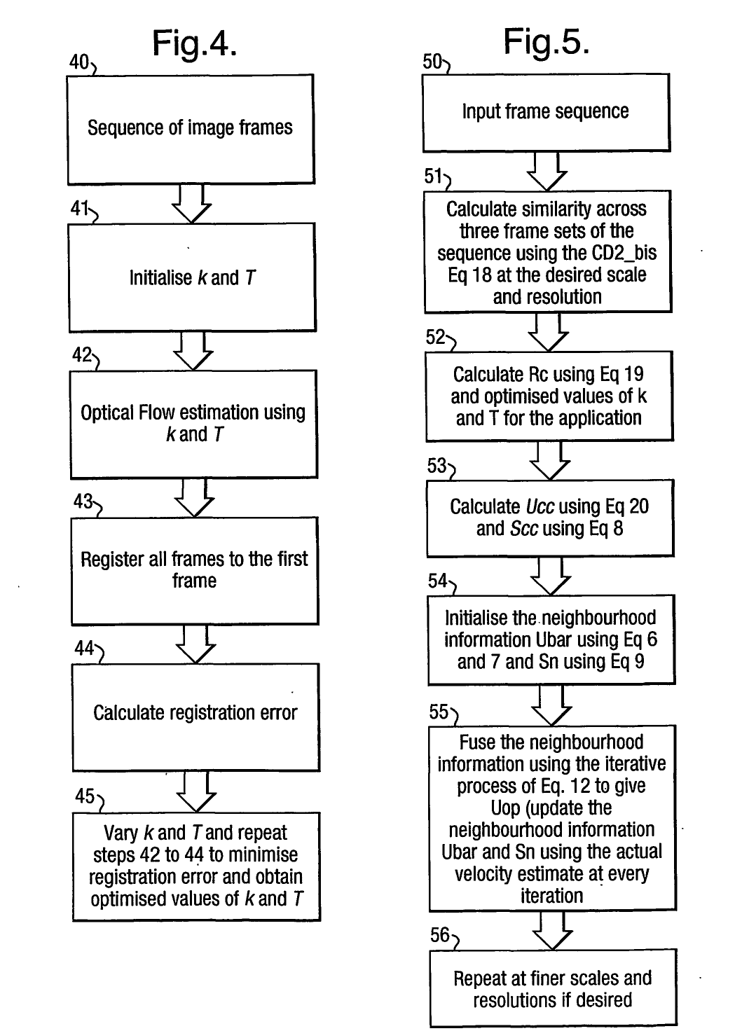

FIG. 4 is a flow diagram of an optimisation process used in one embodiment of the invention;

FIG. 5 illustrates the overall process of one embodiment of the invention; and

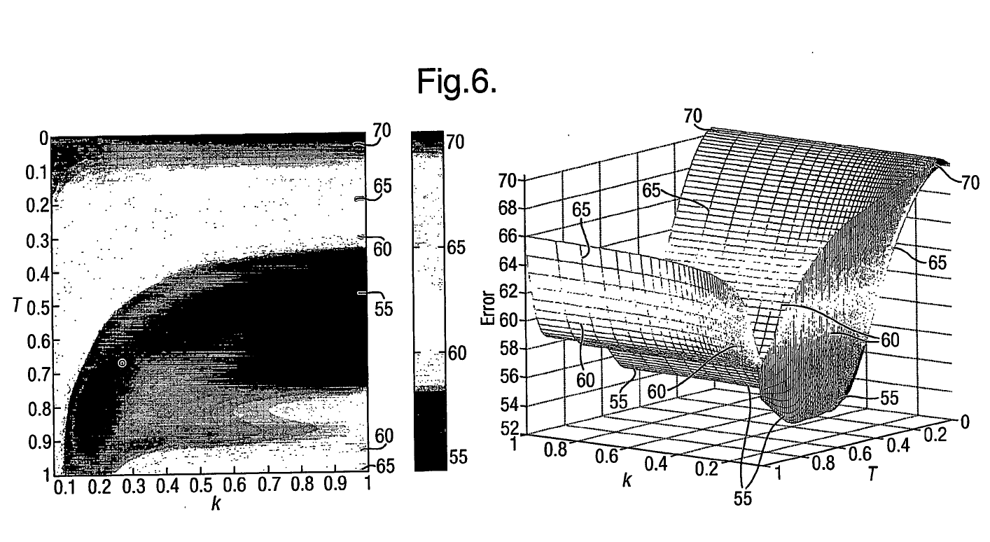

FIG. 6 illustrates the optimisation of k and T for a breast ultrasound image sequence.

Given a sequence of image frames in which it is desired to calculate the image velocity, the first aspect of the invention concerns the similarity measure used, i.e. the calculation of E_{c}(u, v). While the image processing algorithm proposed by Singh uses the sum of square differences as a similarity measure, other similarity measures such as CD₂ and normalised crossed correlation (NCC) are known. In this embodiment a modified version of the CD₂ similarity measure is used. Using the CD₂ similarity measure the most likely value of the velocity is defined as:

$${\hat{v}}_{i}^{ML} = {max}_{{v}_{i}} {\sum }_{j = 1}^{2 n + 1} {x}_{ij} - {y}_{ij} - ln ( exp ( 2 ( {x}_{ij} - {y}_{ij} ) + 1 ) \qquad ( 14 )$$

where here i refers to the block, j indexes the pixels in the block, there are 2n+1 pixels in the block, and xᵢⱼ and yᵢⱼ are the intensities in the two blocks being compared.

This similarity measure is better for ultrasound images than others such as sum-of-square differences or normalised cross-correlation because it takes into account the fact that the noise in an ultrasound image is multiplicative Rayleigh noise, and that displayed ultrasound images are log-compressed. However it assumes that the noise distribution in both of the blocks W_{c} is the same and this assumption is not correct for ultrasound images. The attenuation of the ultrasound waves introduces inhomogeneities in the image of homogeneous tissue. The time gain and the lateral gain compensations (compensating respectively for the effects that deeper tissue appears dimmer and for intensity variations across the beam) which are tissue independent and generally constant for a given location during the acquisition, do not compensate fully for the attenuation. Thus in this embodiment of the invention an intensity normalisation is conducted before calculation of the CD₂ similarity measure. This is achieved by making sure that the two blocks W_{c} of data have at least the same mean and variance. In more detail, the original intensity values xᵢⱼ and yᵢⱼ above are transformed into new values of \tilde{x}ᵢⱼ and \tilde{y}ᵢⱼ by subtracting the mean and dividing by the standard deviation (square root of the variance) of the intensity values in the block. This gives a new similarity measure which can be denoted CD_{2-bis} as follows:

$${E}_{i}^{{CD}_{2 \text{-} bis}} = {\sum }_{j = 1}^{2 n + 1} {\tilde{x}}_{ij} - {\tilde{y}}_{ij} - ln ( exp ( 2 ( {\tilde{x}}_{ij} - {\tilde{y}}_{ij} ) ) + 1 ) \qquad ( 15 )$$

This is the similarity measure used in this embodiment to calculate the values of E_{cc} used.

To avoid multi-modal responses, the similarity measure may be calculated over three consecutive frames. However, rather than making the normal constant velocity assumption as mentioned above and described in relation to FIG. 2, which results in the similarity measure being based on comparing the first frame at time t with the next frame at time t+1 and the third frame at t+2, instead the result of calculating the velocities between the preceding frame at time t−1 and the current frame at time t are used. Given a block in frame xᵢ at time t, which is compared to blocks in the search window Wₛ in frame yᵢ at the time t+1, the position of that block in the preceding frame at time t−1 (denoted oᵢ) has already been calculated and so its position can be denoted (x-u₀, y-v₀) in the preceding frame where (u₀, v₀) was the result of the preceding velocity (image velocity) calculation. Thus in the three frame approach in this embodiment of the invention the intensities of each candidate block in the search window Wₛ are compared with the intensities of the block at (x, y) in the frame xᵢ at time t, and also with the calculated position (x-u₀, y-v₀) of that block in the frame or at time t−1. A value of E is calculated for each comparison (of xᵢ and yᵢ and oᵢ and yᵢ) and the values are summed.

This is illustrated schematically in FIG. 3. The approach is applicable whatever similarity measure is used to compare the intensities. In the case of the sum-of-square differences, the new similarity measure becomes:

$${E}_{c} ( u , v ) = {\sum }_{i = - n}^{n} {\sum }_{j = - n}^{n} ( \begin{matrix}[ I ( x - {u}_{o} + i , y - {v}_{o} + j , t - 1 ) - \\ {I ( x + u + i , y + v + j , t + 1 ) ]}^{2} + \\ {[ I ( x + i , y + j , t ) - I ( x + u + i , y + v + j , t + 1 ) ]}^{2}\end{matrix} \qquad ( 16 )$$

where the first term compares intensities in frames oᵢ and yᵢ, i.e. at times t−1 and t+1, and the second term compares intensities between frames xᵢ and yᵢ, i.e. at times t and t+1.

In the case of CD_{2-bis} similarity measure defined above, the calculation of E over three frames becomes:

$${E}_{i}^{{CD}_{2 - bis}} = [ {\sum }_{j = 1}^{2 n + 1} {\tilde{o}}_{ij} - {\tilde{y}}_{ij} - ln ( exp ( 2 ( {\tilde{o}}_{ij} - {\tilde{y}}_{ij} ) ) + 1 ) ] + [ {\sum }_{j = 1}^{2 n + 1} {\tilde{x}}_{ij} - {\tilde{y}}_{ij} - ln ( exp ( 2 ( {\tilde{x}}_{ij} - {\tilde{y}}_{ij} ) ) + 1 ) ] \qquad ( 17 )$$

or in more detail:

$${E}_{c} ( u , v ) = {\sum }_{i = - n}^{n} {\sum }_{j = - n}^{n} ( \begin{matrix}( \begin{matrix}\tilde{I} ( x - {u}_{o} + i , y - {v}_{o} + j , t - 1 ) - \tilde{I} ( x + u + i , y + v + j , t + 1 ) - \\ ln ( exp ( 2 [ \tilde{I} ( x - {u}_{o} + i , y - {v}_{o} + j , t - 1 ) - \\ \tilde{I} ( x + u + i , y + v + j , t + 1 ) ] ) + 1 )\end{matrix} ) + \\ ( \begin{matrix}\tilde{I} ( x + i , y + j , t ) - \tilde{I} ( x + u + i , y + v + j , t + 1 ) \\ ln ( exp ( 2 [ \tilde{I} ( x + i , y + j , t ) - \tilde{I} ( x + u + i , y + v + j , t + 1 ) ] ) + 1 )\end{matrix} )\end{matrix} ) \qquad ( 18 )$$

Here \overline{I} represents the intensity data I transformed as detailed above (but only, of course, within the interesting block, not for the whole image).

This avoids the assumption that the velocity is the same over the three frames. Instead it looks for the best match in frame yᵢ to the block in xᵢ and the calculated previous position of the block (in oᵢ). It improves the matching process especially at low frame rates, e.g. of 20-30 Hz. This makes it particularly useful in the case of contrast echocardiography, abdominal imaging, tissue Doppler and real-time 3D-imaging, where low frame rates are typical.

Having established the new similarity measure, the next stage is to calculate a probability mass function from the similarity measure. In the Singh approach this was by equation (2) above. As discussed above, that involved setting a value of k for each position in the frame such that the maximum response in the search window was close to unity. However, in this embodiment of the invention the value of k is, instead, set to be the same for all positions in the frame and all frames in the sequence. The value of k is found in an optimisation approach which will be described below. Given the value of k the probability mass function for this embodiment is given by

$${R}_{c} ( u , v ) = \frac{1}{Z} exp ( \frac{k}{{( 2 n + 1 )}^{2}} ( {E}_{c} ( u , v ) - m ) ) , \qquad ( 19 )$$

where m is the maximum of the similarity measure in the search window Wₛ (i.e. for −N≦u, v≦N) which is deducted from E_{c}(u,v) to avoid numerical instabilities.

Thus it can be seen that the similarity measure is modified by dividing the value of k by the size of the block W_{c}. This is necessary so that the optimised value of k calculated for one image sequence can be used at all scales and resolutions (i.e. regardless of the size of the block W_{c} chosen) for that sequence.

The values of the response R_{c} calculated using this equation are then used to calculate expected values of the velocity (u_{cc}, v_{cc}) and the corresponding covariance matrices using equations (4), (5) and (8) above. However, in this embodiment the calculation of the velocities (u_{cc}, v_{cc}) is further modified by using only candidate velocities which have probabilities above a certain threshold α in the velocity estimate of equations (4) and (5) however all candidate velocities are used in the covariance calculation. Thus in this embodiment the velocity estimates are calculated as follows:

$$\begin{matrix}{u}_{cc}^{T} = \frac{{\sum }_{u = - N}^{N} {\sum }_{v = - N}^{N} u {R}_{c}^{T} ( u , v )}{{\sum }_{u = - N}^{N} {\sum }_{v = - N}^{N} {R}_{c}^{T} ( u , v )} \\ {v}_{cc}^{T} = \frac{{\sum }_{u = - N}^{N} {\sum }_{v = - N}^{N} v {R}_{c}^{T} ( u , v )}{{\sum }_{u = - N}^{N} {\sum }_{v = - N}^{N} {R}_{c}^{T} ( u , v )} \\ where , \\ {R}_{c}^{T} ( u , v ) = \{ \begin{matrix}{R}_{c} ( u , v ) & if {R}_{c} ( u , v ) \geq α \\ 0 & otherwise\end{matrix}\end{matrix} \qquad ( 20 )$$

The threshold α is defined as follows:
α=−T( [symbol] − [symbol] ) with Tε[0,1]
where [symbol] and [symbol] are the maximum and minimum of the probability mass function R_{c} (u,v) respectively.

Thus it can be seen that if T is set to 1, the threshold a becomes the minimum value of R_{c}, meaning that all values of the candidate velocities are used in the calculation, and the calculation becomes equivalent to that in the Singh approach. If T=0, on the other hand, the threshold a becomes the maximum value of the response so that only the candidate velocity with maximum probability is taken as the estimated velocity. Thus the estimate would be totally biased towards the predominant mode. In fact the value of T, optimised in the same optimisation process as that used for k, to be explained below, in practice will be between zero and one.

The estimates of velocity and the covariance matrices are used together with neighbourhood information in the iterative process described above to calculate the optimised values of velocity in accordance with equation (12) above.

FIG. 4 illustrates schematically how the values of k and T are optimised together in a 2D space. In step 40 the sequence of images is taken and in step 41 the values of k and T are initialised. Then in step 42 the image velocity is estimated using the initial values of k and T. These initial values may be chosen from experience based on the type of imaging equipment and the subject of the imaging sequence. The process is relatively robust to the choice of k and T, so, for example, initial values of T=0.5 and k=0.5 may be suitable for an ultrasound imaging sequence. Having calculated the image velocity in step 42 it is then possible in step 43 to register all of the subsequent frames to the first frame. “Registering” frames is equivalent to superimposing the images one upon the other and adjusting their relative position to get the best match. In practice the process involves correcting the subsequent frames for motion using the calculated image velocity. Having registered the frames a registration error ξ is calculated using an error function in step 44. As an example, the error function may be a sum of square differences in the intensities of the frames. If the image velocity estimation were perfect, there would be no difference in intensities (as the motion correction would be perfect) and thus the error function would be zero. In practice, of course, the error function is non-zero and so in step 45 the values of k and T are varied to minimise the error function ξ. This may be achieved using a multidimensional minimisation algorithm such as the Powell algorithm (see William H. Press et al., “Numerical recipes in C: The art of scientific computing”, Cambridge University Press). The optimisation process may be continued until the change in the value of the error function ξ is below a certain threshold. In one experiment to compensate a breast compression sequence for distortion the optimal values were found to be T=0.660 and k=0.237. FIG. 6 shows the results of the experiment conducted on the ultrasound breast data. The error shown is the registration error ξ. Two observations can be made:
1. For T=0, the velocity estimation is equivalent to taking the argument of the maximum of the probability. Hence, theoretically, the parameter k does not have any influence on the result. This can easily be observed in this experiment, and it corresponds to the maximum error. In this case, the image velocity is quantified by the pixel resolution of the image, and hence the error on the image velocity is of the order of the pixel resolution. Furthermore, this approach is not robust against noise. This explains this high error on the velocity estimation.
2. For T=1 (as in Singh), the velocity estimation is equivalent to taking the mean of the probability. The results are better than for T=0, but do not correspond to the optimal value. This result can be explained by the fact that taking the mean of the probability as an estimates of the velocity is not very precise and may lead to biased estimation if the pdf is not mono-modal or non-well-peaked pdfs. Observe as well the expected functional dependence between the two parameters (T and k). This last point indicates that the search for the optimal values of T and k should be done in the 2D space. In this experiment the optimal values are T=0.660 and k=0.237. Thus showing a clear distinction from the Singh result.

It should be noted that the improvements above may be used in a coarse-to-fine strategy, i.e. a multiresolution approach in which velocities are first estimated at a low resolution, then at a next finer resolution these estimates are used as a first guess in the estimation process and the estimates are refined. This means that instead of searching in the window around (x, y) in the second frame, one can search around (x+uₑₛₜ, y+vₑₛₜ) where uₑₛₜ and vₑₛₜ are velocity estimates propagated from the coarser level. This approach is computationally efficient. Further, the image velocity estimation may be concentrated on regions of the image in motion, rather than conducted over the whole image.

FIG. 5 illustrates the process flow for the image velocity estimation given values of k and T (e.g. initial values if this is the first estimate for a given application, or optimised values). Firstly, in step 50, a sequence of image frames is taken. Then, in step 51, the similarity measure across three frame sets of the sequence is calculated using the CD_{2-bis} similarity measure, i.e. using equation (18) at the desired scale and resolution. “Resolution” means whether one is sampling every pixel, or only certain pixels in the block W_{c} and “scale” refers to how far the block is displaced in the search window Wₛ, e.g. by one pixel, or by several pixels. Having calculated the similarity values, the value of the response R_{c} can be calculated in step 52 using equation (19). Then in step 53 the value of U_{cc} is calculated using equation (20) and the corresponding covariance matrix S_{cc} using equation (8). In step 54 the value of \overline{U} and the covariance for the neighbourhood estimate is calculated using equations (6), (7) and (9). Then in step 55 the conservation and neighbourhood information are fused using the iterative process of equation (12) to give an optimised velocity estimate Uₒₚ.

As indicated by step 56, the process may be repeated at finer scales and resolutions, with the computational burden being eased by making use of the image velocity estimate already obtained.

The above improvements in the block matching technique are particularly successful in allowing tracking of cardiac boundary pixels in echocardiographic sequences. The block matching steps may be concentrated in a ribbon (band) around a contour defining the cardiac border to reduce the computational burden. However, the technique is applicable to other non-cardiac applications of ultrasound imaging.

1. A method of processing a sequence of image frames to estimate image velocity through the sequence comprising:
block matching using a similarity measure by comparing the intensities in image blocks in two frames of the sequence and calculating the similarity between the said blocks on the basis of their intensities, calculating from the similarity a probability measure that the two compared blocks are the same, and estimating the image velocity based on the probability measure, wherein the probability measure is calculated using a parametric function of the similarity which is independent of position in the image frames.

2. A method according to claim 1 wherein the parameters of the parametric function are independent of position in the image frames.

3. A method according to claim 2 wherein at least one of the parameters is optimised by coregistering the frames in the sequence on the basis of the calculated image velocity, calculating a registration error and varying at least one of the parameters to minimise the registration error.

4. A method according to claim 3 wherein the registration error is calculated from the differences of the intensities in the coregistered frames.

5. A method according to claim 4 wherein the registration error is calculated from the sum of the squares of the differences of the intensities in the coregistered frames.

6. A method according to claim 1 further comprising the step of normalising the calculated similarity with respect to the size of the block and calculating the probability measure on the basis of the normalised similarity.

7. A method according to claim 6 wherein the calculated similarity is normalised by dividing it by the number of image samples in the block.

8. A method according to claim 6 wherein the calculated similarity is normalised by dividing it by the number of pixels in the block.

9. A method according to claim 1 wherein the probability measure is a monotonic function of the similarity.

10. A method according to claim 1 wherein the probability measure is thresholded such that motions in the image velocity whose probabilities have a predefined relationship with a threshold are ignored.

11. A method according to claim 10 wherein the threshold is optimised by coregistering the frames in the sequence on the basis of the calculated image velocity, calculating a registration error and varying the threshold to minimise the registration error.

12. A method according to claim 10 wherein the threshold is positionally independent.

13. A method according to claim 10, wherein the threshold and parameters are optimised together.

14. A method according to claim 1 further comprising normalising the intensities in the two blocks to have the same mean and standard deviation before calculating said similarity.

15. A method according to claim 1 wherein the similarity measure is the CD_{2-bis} similarity measure.

16. A method according to claim 1 wherein the block matching is conducted across three frames of the sequence by comparing the intensities in blocks in the first and third and the second and third of the three frames and calculating the similarity from said compared intensities.

17. A method according to claim 16 wherein the blocks in the first and second frames are blocks calculated as corresponding to each other on the basis of a previous image velocity estimate.

18. A method of processing a sequence of image frames to estimate image velocity through the sequence comprising:
block matching using a similarity measure by comparing the intensities in image blocks in three frames of the sequence by comparing the intensities in blocks in the first and third and the second and third of the three frames, and calculating the similarity between the said blocks on the basis of their intensities.

19. A method according to claim 18 wherein the blocks in the first and second frames are blocks calculated as corresponding to each other on the basis of a previous image velocity estimate.

20. A method according to claim 19 comprising defining for each block in the second frame a search window encompassing several blocks in the third frame, and calculating the similarity of each block in the search window to the said block in the second frame and to the corresponding position of the said block in the first frame based on the previous image velocity estimate.

21. A method of processing a sequence of image frames to estimate image velocity through the sequence comprising:
block matching using a similarity measure by comparing the intensities in image blocks in two frames of the sequence and calculating the similarity between the said blocks on the basis of their intensities, further comprising normalising the intensities in the two blocks to have the same mean and standard deviation before calculating said similarity.

22. A method according to claim 21 wherein the similarity measure is the CD_{2-bis} similarity measure.

23. A method according to claim 21 wherein the block matching is conducted across three frames of the sequence by comparing the intensities in blocks in the first and third and the second and third of the three frames and calculating the similarity from said compared intensities.

24. A method according to claim 23 wherein the blocks in the first and second frames are blocks calculated as corresponding to each other on the basis of a previous image velocity estimate.

25. A method according to claim 1 wherein the image velocity estimate is refined by modifying the image velocity estimate at each position in the image with the estimated image velocity at surrounding positions.

26. A method according to claim 1 wherein the images are medical images.

27. A method according to claim 1 wherein the images are ultrasound images.

28. Image processing apparatus comprising an image velocity estimator adapted to estimate image velocity in accordance with the method of claim 1.

29. A computer program comprising program code means for executing on a programmed computer the method of claim 1.

30. A computer-readable storage medium storing a computer program according to claim 29.
